(19) United States
(12) Patent Application Publication
(10) Pub. No.: US 2012/0117984 A1
(43) Pub. Date: May 17, 2012

(54) VALVE ASSEMBLY ADAPTED FOR DYNAMIC CONTROL OF GAS-FLOW ABOUT A CRYOGENIC REGION

(75) Inventor: Michael Bancroft Simmonds, San Diego, CA (US)

(73) Assignee: QUANTUM DESIGN, INC., San Diego, CA (US)

(21) Appl. No.: 12/944,517

(22) Filed: Nov. 11, 2010

(51) Int. Cl. F25B 9/14; G05D 7/06; F16K 31/08

(52) U.S. Cl. 62/6; 251/129.15; 700/282

(57) ABSTRACT

A valve assembly is provided for dynamically controlling the inlet and exhaust of refrigeration gas between a cryocooler coldhead and a remote compressor. The valve assembly is optimized to minimize friction, power consumption, and wear while providing complete flexibility as to the timing, duration, and amplitude of its inlet and exhaust actions. The valve assembly comprises two separate open-close sections for the inlet and exhaust functions. These are mounted along a single rod, the position of which is controlled by a linear motor. The two sections are configured so that only one is open at each the rod's travel and neither is open at the midpoint of travel. A microprocessor and appropriate drive circuits precisely control the position of the rod as a function of time, and of displacer position when used with a Gifford-McMahon (G-M) cooler.

### FIELD OF THE INVENTION

This invention relates to cryogenic refrigeration systems commonly referred to as “cryocoolers”; and more particularly to a valve assembly for dynamically controlling a flow of gas-phase coolant about one or more cryogenic regions of a cryocooler.

### BACKGROUND OF THE INVENTION

A myriad of medical and scientific systems require the use of cryocoolers for cooling or condensing a gas-phase coolant such that refrigeration of these systems may be adequately achieved. For example, magnetic resonance imaging (MRI) and other related equipment typically require the operation of superconducting magnets which operate at extremely low temperatures. Other systems, and in particular certain laboratory analytical systems, require operation at low temperatures and may incorporate the use of a cryocooler for circulating coolant within the system.

In general, cryocoolers can be classified into two main groups: Stirling-type coolers which do not require valves and all other cryocoolers which require one or more valves positioned between a remote compressor and a cooler head; also referred to as a “cold head”. These valves are ideally located near the cold head of the cryocooler for increased cooling efficiency.

One example of a commonly available valve for use with cryocoolers includes a rotary valve, as described in U.S. Pat. No. 6,460,349, titled “ROTARY VALVE IN A PULSE TUBE REFRIGERATOR”; the entire contents of which are hereby incorporated by reference. The rotary valve provides inlet and exhaust function by utilizing apertures or passageways in a hard-surfaced, rotating valve plate. Here, the valve plate is pressed tightly against a softer, fixed valve seat. The high force between the valve seat and valve plate is necessary to reduce gas-leakage therebetween. When used with Gifford McMahon (GM) cryocoolers, the valve plate is rotated by the same motor that moves the displacer assembly up and down (typically using a scotch yoke or similar rotary-to-linear crank mechanism). This mechanical linkage between the valve plate and displacer automatically provides the required phase relation between displacer position and pressure oscillations that are required for refrigeration.

For many years, this simple and purely mechanical valve actuation has proven to be an economical and reliable solution to the problem of gas control in GM cryocoolers. The rotary valve is also used with more recent pulse-tube coolers; however, in this application the motor merely drives the rotary valve as there is no moving displacer in the pulse tube design.

There are, however, a number of problems associated with these types of rotary valves. First, the high force required between the valve plate and valve seat results in significant wear of the seat, generating debris and necessitating replacement of the seat at regular intervals. For example, debris from wear of the rotary valve can cause contaminants within the system; these contaminants can be introduced into the valve assembly, causing the system to lock up, possibly causing damage to the motor. This wear remains a problem despite the use of very highly engineered materials for the seat and plate. A second problem is that the inlet/exhaust timing, dwell, and flow area are completely fixed by the construction of the valve seat and plate. This precludes the possibility of adaptively optimizing the cryocooler's performance with regard to cooling power, efficiency, or vibration level.

When cryocoolers are only used for cooling MRI machines or for cryopumps, these limitations are not particularly important. However, as cryocoolers are more fully integrated into sophisticated cryogenic instruments, the limitations of the classic rotary valve become more apparent.

Another type of valve has been contemplated for use in cryocooler applications. U.S. Pat. No. 4,522,033, titled “CRYOGENIC REFRIGERATOR WITH GAS SPRING LOADED VALVE” describes a linear valve mechanically driven by a cam linkage and attached to a common motor for driving both the valve and a displacer within a GM-type cryocooler; the entire contents of which are hereby incorporated by reference. This type of linear valve was first introduced as a spring-loaded valve, however problems associated with rapid failure of the spring necessitated an improvement. The '033 patent provides a linear valve having a compressed gas region for replacing the spring within the linear valve. One problem with this valve includes a fixed phase-relationship between the displacer and the valve as both are commonly driven by the same motor and cam assembly. In this regard, the valve is dependent on displacer mechanics which precludes the possibility of adaptively optimizing cryocooler performance.

Additionally, there has yet to be provided a valve adapted for dynamic control of coolant about one or more cryogenic regions of a cryocooler using a computerized control mechanism. Such a valve could provide improved precision and control over the input and exhaust of gases within a cryocooler. With added precision, pressure changes within the cryocooler can be managed such that common problems including noise and losses due to fluid-friction are minimized. Such a valve, not being dependent on displacer mechanics, may also prove to be useful with modern pulse-tube cryocoolers.

It would therefore be an improvement in the art to provide a valve adapted for dynamic control of the flow of coolant about one or more cryogenic regions of a cryocooler, the valve adapted for resilient and durable operation over an extended period of time. It would be a further benefit to provide a valve assembly adapted to optimize cryocooler performance with regard to cooling power, efficiency, and vibration level. It would be of particular benefit to provide a valve adapted for control of gas-flow independently from displacer mechanics. It would further be of benefit to provide a heating mechanism to the cryocooler using a valve capable of reversing input and exhaust flow mechanics, effectively warming the system. Finally, it would be of benefit in the art to provide a valve adapted for dynamic computerized control of a valve, thereby providing incremental and precise control of inlet and exhaust functions. Other valuable features of an improved cryocooler valve will become apparent to one having skill in the art upon further review of the embodiments described herein.

### SUMMARY OF THE INVENTION

It is therefore an objective of the invention to provide a durable valve assembly for use in regulating an exchange of gases between a compressor and a cold head. It is another objective of the present invention to provide a valve assembly adapted for dynamic control of input and exhaust mechanics using a microprocessor or other computerized controller. In addition to cooling, the valve assembly can be adapted to provide temperature control in the positive direction by reversing the phase of inlet and exhaust functions.

In one embodiment of the invention, a valve assembly includes an armature and a stator positioned within a housing member. The armature includes a linear rod extending along a translational axis from a proximal end to a distal end, and is adapted to at least partially comprise an electromagnetic motor disposed at the proximal end and at least one circumferential notch disposed along a length of the armature. The electromagnetic motor can comprise a coiled conductor wire disposed or wound about the armature at a proximal end. The stator may include one or more fixed permanent magnets disposed adjacent to a base portion of the housing member. The base of the housing may further comprise a magnetic portion fabricated from one or more of iron, nickel, and cobalt. It is also within the scope of the invention to provide a fixed electromagnetic coil within the housing or base for varying a magnetic field. Furthermore, the translational armature may be fitted with a permanent magnetic moment and the housing can be varied electromagnetically to translate the armature therein.

An elongated sleeve is disposed within the housing member and adapted for coaxial positioning with the armature. The elongated sleeve further comprises two or more axially spaced peripheral grooves, wherein each of the peripheral grooves comprises a plurality of radial ports extending from an inner diameter surface to an inner groove surface. Furthermore, each of the axial spaced peripheral grooves is connected to one of an input or exhaust port of a coldhead or compressor unit.

In this embodiment, the armature is adapted to translate along the translational axis between two or more translational points within the housing. In this regard, at each of the translational points at least one circumferential notch of the armature is adapted to align with one or more peripheral grooves of the elongated sleeve for promoting, preventing, or restricting a flow of gas through the valve.

In another embodiment, the armature includes two circumferential notches disposed along a length of the linear rod portion of the armature. The elongated sleeve includes four peripheral grooves, each peripheral groove is connected to one of an input or exhaust port of the housing. A current is variably provided to the coiled conductor forming a variable magnetic field, and the armature translates with respect to the fixed magnetic field of the stator. In essence, the valve acts as a linear motor having circumferential notches for regulating gas between one or more axially spaced peripheral grooves of the elongated sleeve.

In a preferred embodiment, at least a portion of the linear rod is coated with a polymer, for example poly-tetrafluoroethylene (PTFE), or a similar material. Furthermore, the elongated sleeve is fabricated from a durable metal, for example stainless steel or brass. The PTFE-coated armature is therefore adapted to translate within the durable metal sleeve such that friction is reduced and durability of the actuator is improved. Additionally, the inner diameter of the elongated sleeve can be machined to closely match the outer diameter of the linear rod such that gas-leakage can be minimized. In this regard, the PTFE can act as a lubricant and at least partially seal an area between the armature and the elongated sleeve.

In another preferred embodiment, each of the peripheral grooves of the elongated sleeve is adapted to constantly provide a positive pressure. In this regard, the linear rod portion of the armature can be adapted to float within the valve assembly, requiring less energy from coiled conductor wire, and reducing friction thereby enhancing durability of the valve components. Each end of the valve can be maintained at an equilibrium pressure by providing a gas communicator extending therebetween such that the valve is not resistively biased to a fixed position. The gas communication can include a pair of vent holes and a connection therebetween for communicating gas from a first region to a second region. Without a springing force, the valve is adapted to operate with less translational force and therefore less energy is required of the valve.

In yet another embodiment, the valve assembly includes a plurality of vent holes within the housing to provide equalization of pressures within the housing itself, such that the linear motor of the armature and stator is not impeded by external forces.

In another embodiment, the armature further includes a code strip and the housing further comprises a code reader, such as a quadrature encoder chip. The encoder chip can be linked to a microprocessor having a memory for storing data within a lookup table relating to optimal translation states. In this regard, the microprocessor can dynamically control temperature, noise, and other features of the cryocooler by translating the armature to a point adapted to open, close, or restrict gas-flow between the compressor and the cold head.

### BRIEF DESCRIPTION OF THE DRAWINGS

These and other attributes of the invention are further described in the following detailed description, particularly when reviewed in conjunction with the drawings, wherein:

FIG. 1 illustrates a partial cross-section view of the valve assembly according to one embodiment of the invention, the valve assembly including a housing containing an elongated sleeve having a plurality of peripheral groves and an armature for translating within the elongated sleeve for regulating gas-communication between the peripheral grooves therein.

FIG. 2a further illustrates a partial section view of the elongated sleeve and received armature of FIG. 1; the armature includes a pair of circumferential notches for translationally aligning about the peripheral grooves of the elongated sleeve, thereby providing a linear valve.

FIG. 2b further illustrates the armature having a pair of circumferential notches axially disposed along a length of the rod portion of the armature.

FIG. 3 illustrates a perspective view of the elongated sleeve according to certain embodiments of the invention wherein the sleeve includes four peripheral grooves each comprising a plurality of radially disposed apertures and separated by a number of o-ring grooves for providing a seal therebetween.

FIG. 4 illustrates a cross-section view of the housing member of the valve assembly, the housing including a plurality of o-rings for providing a seal between an inner wall of the housing and several o-ring grooves of the elongated sleeve; a code reader is further illustrated for reading an instantaneous position of the armature within the housing.

FIG. 5a illustrates a partial cross-section view of the valve assembly according to a first state, wherein the inlet region is opened such that the compressor supply port is in gas-communication with the coldhead input port.

FIG. 5b illustrates a partial cross-section view of the valve assembly according to a second state, wherein the armature is translated such that each of the input and exhaust ports are closed, thereby preventing a gas-communication therebetween.

FIG. 6 illustrates a partial cross-section view of a valve assembly according to another embodiment of the invention, wherein the compressor input port is disposed on a first side of the valve housing and the compressor return and coldhead ports are each disposed on a second side of the housing opposite of the first side.

FIG. 7 illustrates a perspective view of the valve assembly according to one embodiment of the invention.

### DETAILED DESCRIPTION

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

For purposes of this invention, the phrase “promoting a flow of gas” is provided herein to describe a state of a valve, wherein the valve includes an armature translated to a position such that a circumferential notch thereon is aligned with a peripheral groove of a coaxially disposed elongated sleeve to provide an opening through which a gas may freely flow.

The phrase “preventing a flow of gas” is provided herein to describe a state of a valve, wherein the valve includes an armature translated to a position such that a bearing surface thereon is aligned with a peripheral groove of a coaxially disposed elongated sleeve to provide a seal at which a gas can be prevented from communication across the valve.

The phrase “restricting a flow of gas” is provided herein to describe a state of a valve, wherein the valve includes an armature translated to a position such that a circumferential notch thereon is partially aligned with a peripheral groove of a coaxially disposed elongated sleeve to provide a partial opening through which a gas may restrictively flow.

In a general embodiment of the invention, a valve assembly includes a linear motor comprising an armature at least partially coated with a polymer or similar composition, such as PTFE. The valve further includes an elongated sleeve fabricated from a resilient metal, such as stainless steel or brass; the sleeve having an inner diameter adapted to receive the outer diameter of the armature within a tight tolerance, such as about 0.01 millimeters. The armature coating serves to lubricate and seal a space between the armature and elongated sleeve. The armature is adapted to translate along a linear translational axis within the elongated sleeve between two or more translational points. The armature further comprises one or more circumferential notches, and the elongated sleeve further comprises two or more axially spaced peripheral grooves, wherein each of the one or more circumferential notches of the armature is adapted to open, close, or partially open access between two or more peripheral grooves.

The linear valve assembly of the present invention provides certain key benefits and operational functions which are useful within the field of refrigeration and cryocoolers. One unique feature of the liner valve assembly includes significantly improved durability and component longevity. Because the translating armature is at least partially coated with PTFE, or a similar material, and because the sleeve containing the armature is fabricated from a resilient metal such as stainless steel or brass, the valve is adapted to provide a maximum durability and longevity throughout its operational life. In this regard, debris from frictional movement of the valve is minimized resulting in a highly efficient and durable valve design.

Another unique feature of the invention relates to the two or more peripheral grooves and radial apertures of the elongated sleeve being disposed adjacent to the armature for providing a positive pressure between each groove and the armature. In this regard, the armature is adapted to float along the translational axis between the grooves of the elongated sleeve, thereby providing less friction and improved durability. The floating aspect of the armature effectively minimizes friction between the armature and the elongated sleeve, thereby reducing wear and effectively reducing contaminants entering into the valve assembly and cold head. It is important to note that there is constantly a positive pressure between each of axial spaced peripheral grooves and the armature whether the valve is in an open or close position, thereby continuously floating the armature within the elongated sleeve.

Furthermore, the floating aspect of the armature provides a lower power consumption thereby enhancing efficiency of the entire system. For example, the valve according to certain embodiments of the invention requires a mere 0.1 Watts as opposed to the prior art rotary valves which consume on the order of 20 Watts of power. Also, the features of less power requirement and less friction result in a significant reduction in noise produced from operation of the valve. Reduced noise is a significant benefit when the valve is used by sensitive analytical equipment, providing improved accuracy in measurements. Accordingly, the valve assembly can be directly mounted to the cold head end of a Gifford-McMahon or pulse-tube cryocooler without increasing noise. For at least these reasons, the valve assembly provides a more efficient and durable mechanism for controlling gas-transfer between a compressor and a cold head than prior art valves.

Still further, another unique feature of the invention includes dynamic control of the valve assembly between full and partial opening and closing of desired ports to effectuate temperature, noise, and other controls. As described above, prior art valves are dependent on the cryocooler displacer for valve mechanics. In the present invention, the valve mechanics are controlled separately from displacer mechanics, in fact a cryocooler displacer and linkage are not required for the present valve to operate. Accordingly, pressure pulses within the cryocooler can be dynamically controlled between a minimum and maximum value by restricting gas-flow through the valve assembly. This cannot be accomplished using prior art valves.

The armature can be fitted with an attached code strip and the housing can further comprise an integrated quadrature code chip connected to a microprocessor. In this regard, the microprocessor can include memory for storing information for translating the armature to promote, prevent, or restrict gas-flow about the cryocooler. Furthermore, the microprocessor can control inlet and exhaust timing. The valve assembly can therefore be adapted for computerized dynamic control, and the cryocooler environment can dictate operation of the valve in real-time. In certain embodiments, the code strip and quadrature chip reader can be replaced with analog capacitive and inductive sensors for determining a linear position of the armature along the translational axis. Other linear translational positioning components can be incorporated in place of a code strip as would be recognized by one having skill in the art.

Additionally, because the linear valve is controlled separately from the displacer mechanics of the cryocooler, it is therefore capable of use with pulse-tube cryocoolers which do not include a mechanical displacer. In one unique aspect of the invention, the valve can be configured to operate in a reverse-phase for effectively warming the cryocooler system. This separation of gas-flow and displacer mechanics is not available in prior art valves.

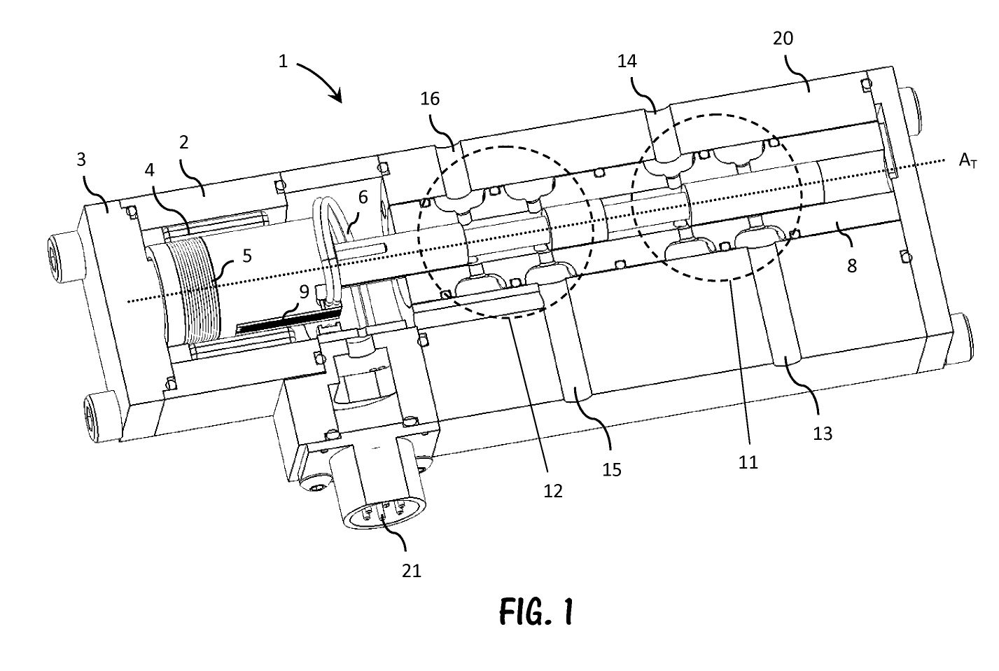

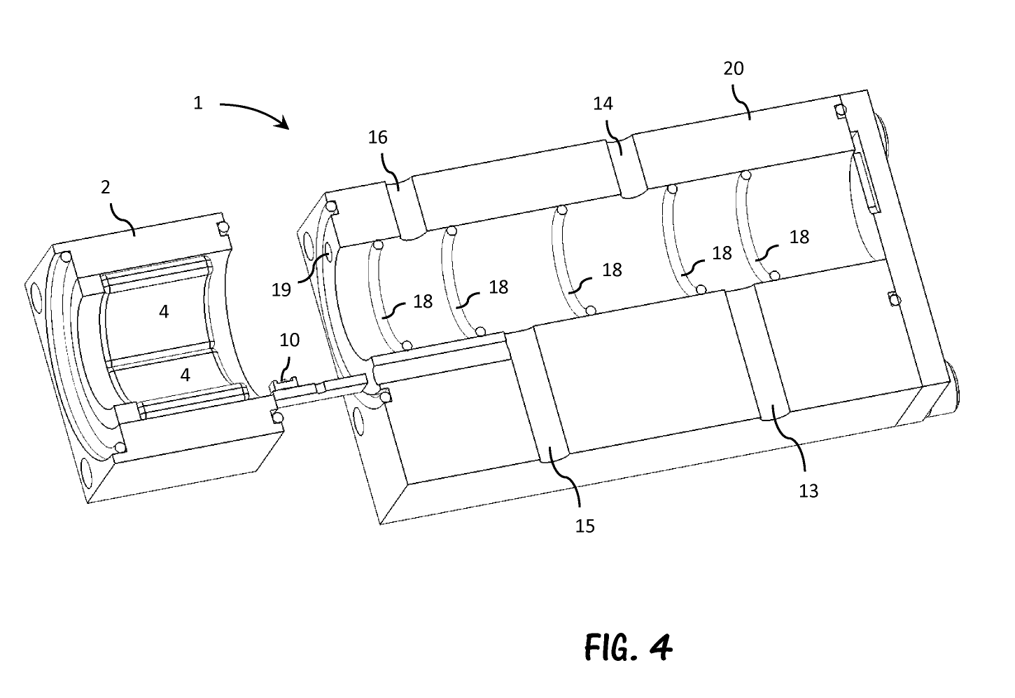

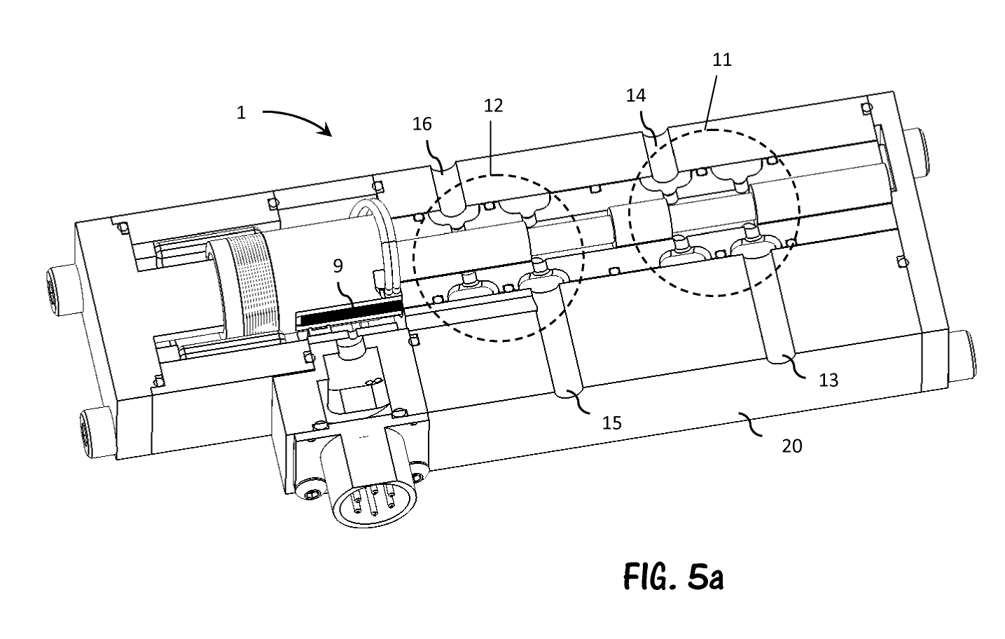

Now turning to the figures, FIGS. 1-4 illustrate the mechanical portions of the valve system 1 according to one embodiment of the invention. The outer housing 20 provides fittings and seals for connecting the valve assembly 1 to a compressor as well as to a cryocooler head. An elongated sleeve 8 is fitted into the outer housing and its separate cavities are sealed radially to the housing by an array of five O-rings 18. The iron pole pieces 2 and 3 along with the permanent magnets 4 provide a strong radial magnetic field in the region of the electrical winding 5. This winding is energized through flexible leads 6. These elements (2 . . . 6) comprise a linear motor that moves an armature 7 back and forth in the sleeve along a translational axis (A_{T}) by a distance of approximately between 3 mm and 60 mm, and preferably about 13 mm.

The incremental position of the rod is continuously measured by an optical system comprising a code strip 9 and an integrated quadrature encoder chip 10. The encoder chip 10 can be connected to a main controller by a controller cable connected to the controller connection port 21. The main controller may be microprocessor based such as a computer having a central processing unit, memory (RAM and/or ROM), and associated input and output buses. The main controller may be an application-specific integrated circuit or may be formed of other logic devices known in the art.

The two separate valve sections, inlet (intake) and exhaust are indicated by regions labeled 11 and 12, respectively. The inlet region 11 includes a compressor supply port 13 connected to a first peripheral groove 22, and a coldhead inlet port 14 connected to a second peripheral groove 23 axially spaced at a distance from the first peripheral groove 22 along the translational axis (A_{T}). The armature 7 is adapted for translational movement such that a first circumferential notch 30 of the armature 7 can be translationally aligned to open a gas-communication between the first peripheral groove 22 and the second peripheral groove 23 across the first circumferential notch 30, effectively communicating a gas flow between the compressor supply port 13 and the coldhead inlet port 14. Similarly, the exhaust region 12 includes a compressor return port 15 connected to a third peripheral groove 24, and a coldhead exhaust port 16 connected to a fourth peripheral groove 25 axially spaced at a distance from the third peripheral groove along the translational axis (A_{T}). The armature 7 is further adapted for translational movement such that a second circumferential notch 31 of the armature 7 can be translationally aligned to open a gas-communication between the third peripheral groove 24 and the fourth peripheral groove 25 across the second circumferential notch 31, effectively communicating a gas flow between the compressor return port 15 and the coldhead exhaust port 16.

It is important to note that each peripheral groove of the elongated sleeve comprises a plurality of radially disposed apertures 26 extending along a circumference of the groove. One having skill in the art would recognize that whether open or closed by the armature, each peripheral groove 22-25 will maintain a positive pressure, that positive pressure being communicated to the armature through each of the radially disposed apertures 26 such that the armature is adapted to float within the elongated sleeve with minimal translational resistance.

The bearing surfaces 17 of the armature are made from a polymer composite such as poly-tetrafluoroethylene (PTFE) alloyed with harder particles such as polyimide. They are bonded to three enlarged sections carefully spaced along the armature 7 so as to provide the desired valve action as it moves with respect to the sleeve 8. The sleeve is made from a metal that works optimally against the polymer bearings to minimize wear of both materials. Stainless steel or brass are suitable materials. The diameters of the bearing surfaces are matched carefully to the inside diameter of the sleeve so as to balance the requirements of low leakage and low friction. For a typical bore diameter of 8 mm, a working clearance of 0-0.01 mm is suitable. It should further be noted that the positive pressure in each peripheral groove can be utilized to minimize leakage between two or more of the grooves when pressure is closely matched at each inlet and exhaust ports; thereby effectively negating diffusion forces between the peripheral grooves.

Vent hole 19 in the housing connects the left end of the armature to the compressor return port. There is a second vent hole (not visible) that runs the length of the housing and connects the right end of the armature the return port. The purpose of these two vents is to equalize the pressure on the ends of the armature so that the linear motor does not need to work against any differential pressures other than those arising from small transient effects during valve transitions. This is an important design element since the axial force on the armature could be as much as 70 Nt (15 lbf). The transient axial forces are at least 10 times smaller than this.

One might be tempted to simplify the two-section valve described above and use a traditional 3-way valve with a single port into the cold head that was alternatively opened to the compressor supply and return ports. One problem with this simplified design is that the return side of the compressor presents suction between the holes in the sleeve and the bearing surface. This suction pulls the bearing surface tightly against the inside surface of the sleeve, greatly increasing the sliding friction. This is the principle of the vacuum chuck, and it is very effective at locking of the armature when any substantial negative pressure difference is present. Conversely, the design presented herein always has a positive pressure between the sleeve apertures and the bearing surfaces. This creates an air bearing that floats the armature. In fact, it is observed that less force (i.e. winding current) is needed to move the armature when the valve is pressurized with helium gas in normal operation. This is a key element of the valve's mechanical design.

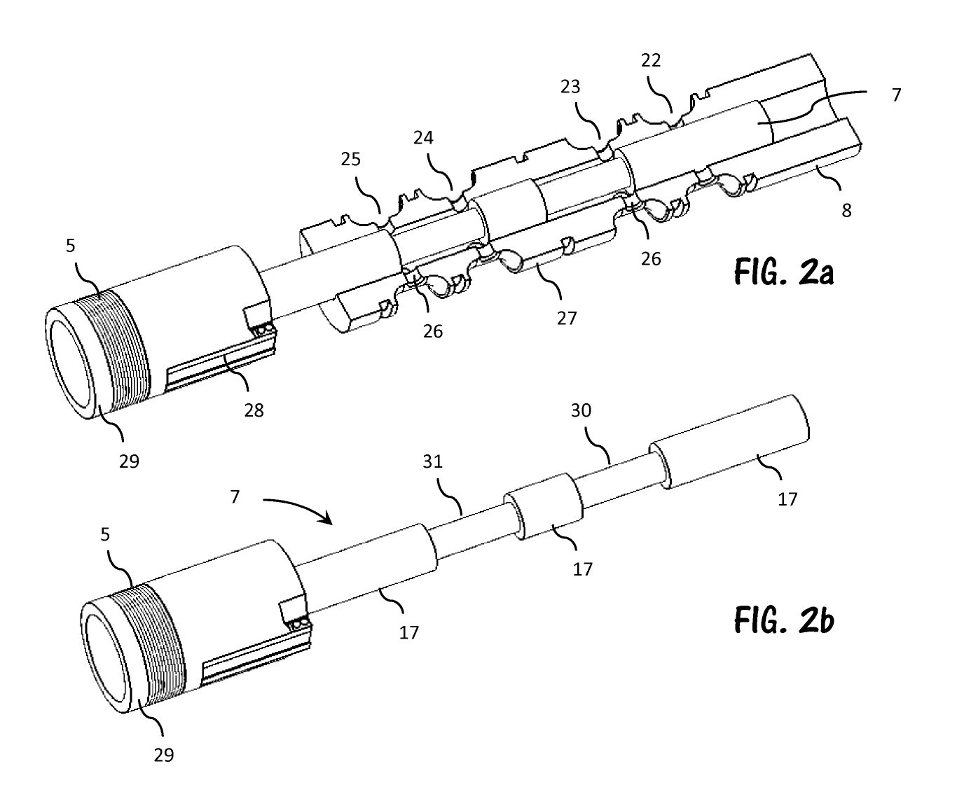

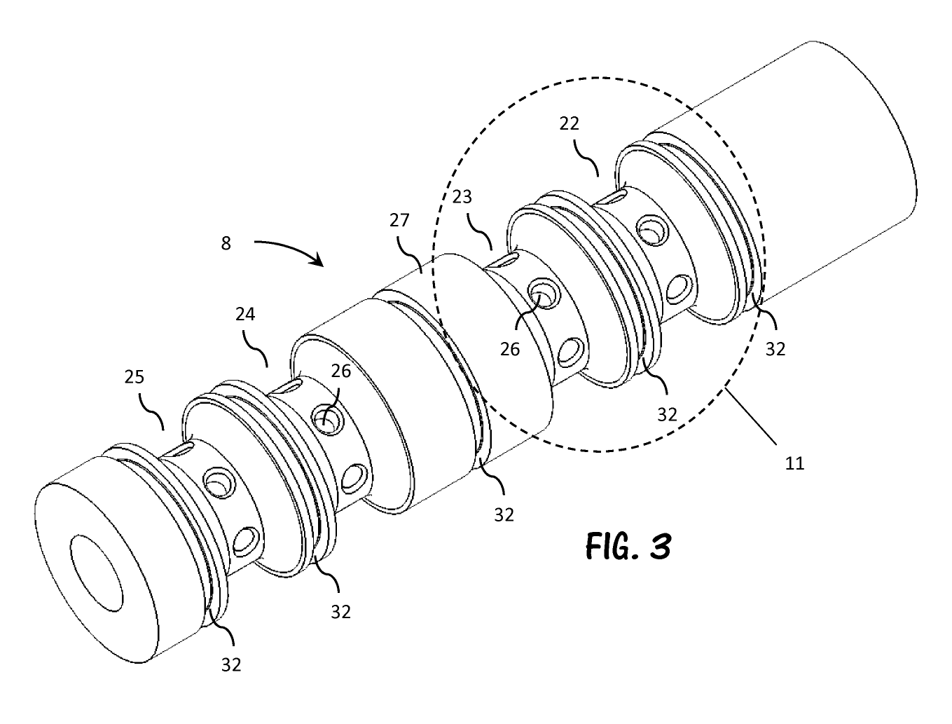

As can be understood by a review of FIG. 2a and FIG. 3, the elongated sleeve 8 includes a plurality of peripheral grooves 22; 23; 24; and 25 axially spaced along the elongated sleeve. Between each peripheral groove is an o-ring groove 32 for receiving an o-ring. Each o-ring 18 forms a seal between the adjacent peripheral groove and the inner surface of the housing member. The peripheral grooves further include a plurality of radially disposed apertures 26 extending along a circumference of each peripheral groove. Additionally, the armature can be adapted with a slot 28 for receiving a code strip 9.

The armature 7 is adapted to translate between multiple translational points along the translational axis (A_{T}); thereby providing a valve function between a remote compressor and one or more cryogenic regions of the cryocooler. For example, as the armature is retracted into the motor housing (as illustrated in FIG. 1) the compressor return port 15 is connected to the cold head exhaust port 16 across the second circumferential notch 31 of the armature, as seen in region 12. Here, the exhaust function of the valve is enabled, establishing a gas communication between the coldhead exhaust port and the compressor return port.

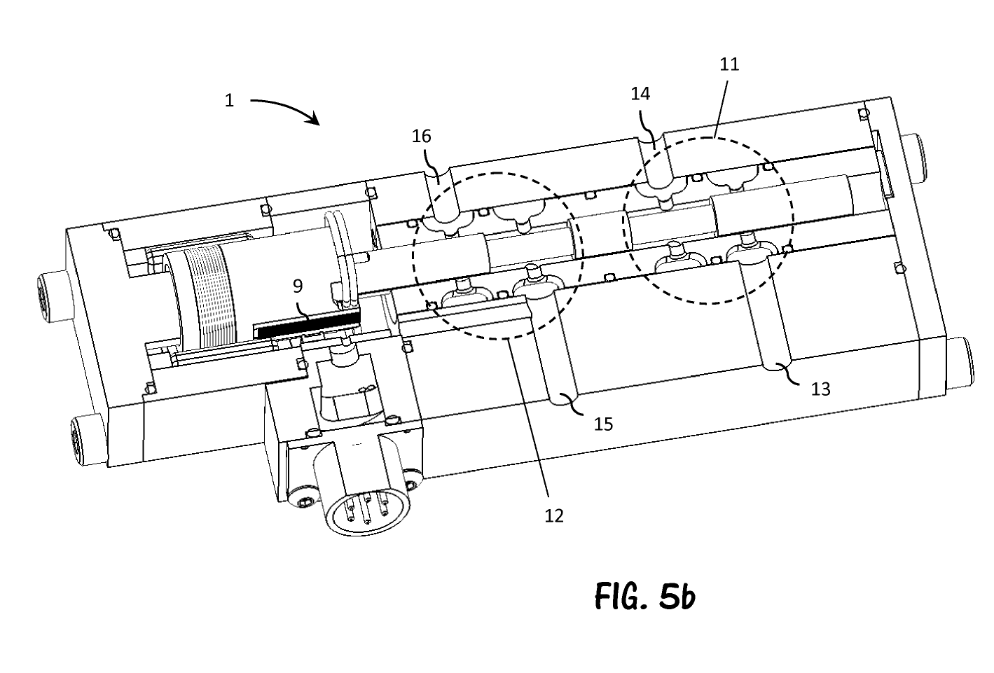

Conversely, as illustrated in FIG. 5a, when the armature is extended outwardly to a distal point along the translational axis, the compressor supply port 13 is opened to head inlet port 14 by communicating the plurality of apertures 26 of the first and second peripheral grooves 22; 23 about the first circumferential notch 30 of the armature 7. In this state, the valve effectively provides a gas flow from the compressor to the coldhead as the input region 11 is opened.

Finally, when the armature is at its midpoint position, as illustrated in FIG. 5b, both inlet and exhaust sections are closed, sealing gas in the cold head and preventing gas-flow into or out of the compressor.

A skilled artisan will recognize that because the armature translated separately from the cryocooler displacer, the armature can be independently and dynamically controlled. For example, the armature can be translated to a position such that a partial opening is provided with respect to the linear valve; effectively restricting or providing a restricted gas-flow between either the inlet or exhaust regions. In this regard, the armature can restrict a flow in or out of a desired port, such as for example the compressor return port. Additionally, the valve can be controlled to reverse the phase of input and exhaust between the compressor and coldhead, thereby providing a reverse mechanism for effectively heating the cryocooler; for example where a warm-up is required for maintenance or other purposes.

Other features of the invention are further described herein. The valve motion can be controlled in many ways using standard feedback control theory. Since the linear motor and code strip behave as an exact analog of a d.c. motor with an encoder there are many servo control boards and modules available. For controlling the motion of the displacers in a G-M cold head as well as the valve, one may use an integrated electronic system comprising microprocessor, quadrature counter, and MOSFET full-bridge driver. An optical interrupter can be used to generate a pulse exactly at the bottom of the displacer stroke for synchronizing the phase of the valve motion to the displacer motion. The microprocessor memory contains time-position tables that the proportional feedback system uses to control the motion of the armature. The tables set the open-time (dwell) of the inlet and exhaust phases as well as the time between these phases. Different tables provide optimum behavior under different operating conditions. In addition to the choices of table, one may also change the absolute phase between the valve pattern and the motion of the displacer. This can be done on the fly to maximize efficiency. Additionally, the amplitude of the motion can be controlled dynamically. With full proportional control, it is not necessary to fully open the valve in either direction. For reduced noise and helium consumption (lower compressor power), the valve stroke can be limited in either direction, opening the port only partially. This reduces the gas flow rate through the cold head passages and regenerator matrixes.

As described above, the absolute phase of the valve can be used to reverse the direction in which the G-M cryocooler pumps heat. This trick has proven to be an excellent way to quickly and thoroughly warm the cold head stages to ambient temperature or even higher without using any heaters. It has also been shown to clean condensed contaminants out of the regenerator matrix more effectively than traditional methods of warming since heated gas is flushed upward through the matrix throughout the procedure.

A less obvious use of phase adjustment includes holding the cryocooler stably at any temperature from its lowest value to above ambient without any use of heaters. This is a great advantage in a variable-temperature instrument since it eliminates the need for high heater power on the experimental stages. Heaters when run at high power create noise and large thermal gradients that make accurate thermometry difficult. Without this scheme for adjusting the cooling power from positive to negative values, it is not possible to stabilize the bottom stage of a G-M cryocooler to any desired temperature.

Note that these techniques of warming the cold head and adjusting its operating temperature are only possible with the G-M design, since the pulse tube generates the phase difference between mass and pressure based on its internal construction.

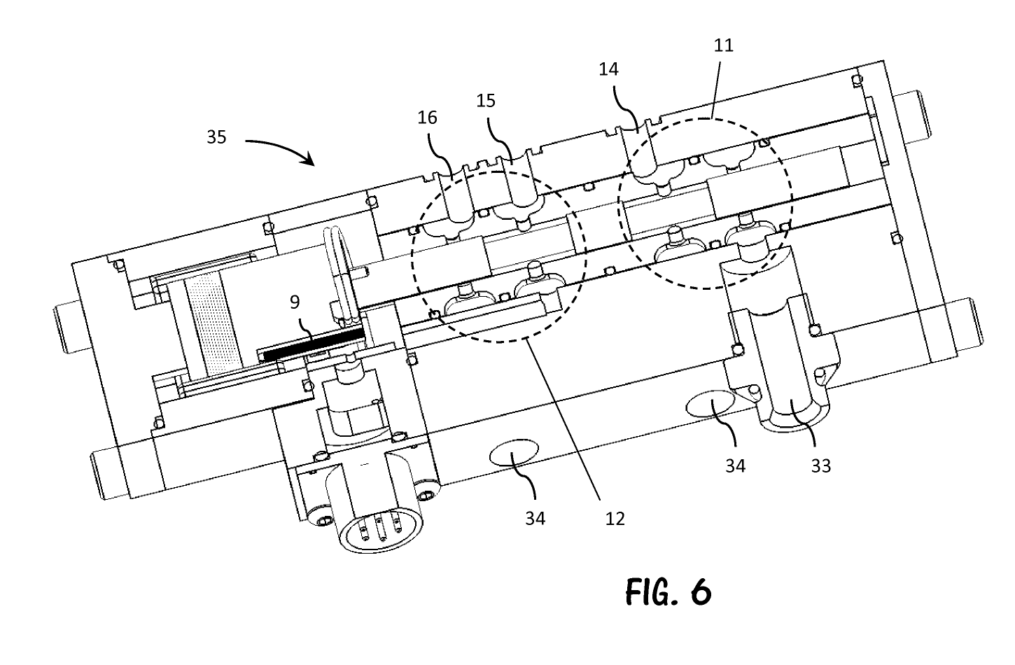

In another embodiment, as illustrated in FIG. 6, a valve assembly 35 is provided. The valve assembly 35 includes a coldhead input port 14, compressor return port 15, and exhaust port 16 positioned on a first side of the valve housing, and a compressor supply port 33 positioned on a second side of the valve housing opposite of the first side. In this regard, one having skill in the art will recognize that each of the inlet and exhaust ports can be positioned on any side of the housing to simplify attachment to the desired coldhead and compressors. The valve assembly of FIG. 6 is adapted to be mounted directly onto the coldhead at the first side. Placing the return port 15 on the same side as the inlet and exhaust ports 14; 16 provides a convenient mechanism to route this returning gas through the mechanical components of the cold head and past the motor in G-M designs. This helps flush any grease vapors away from the cryogenic components and back to the compressor where they are trapped. It also provides cooling for the motor. The compressor supply port includes a fitting 33 for connecting a tubing for communication with the compressor. Optionally, a pair of mounting apertures 34 can be provided for bolting or otherwise attaching the valve assembly to the coldhead.

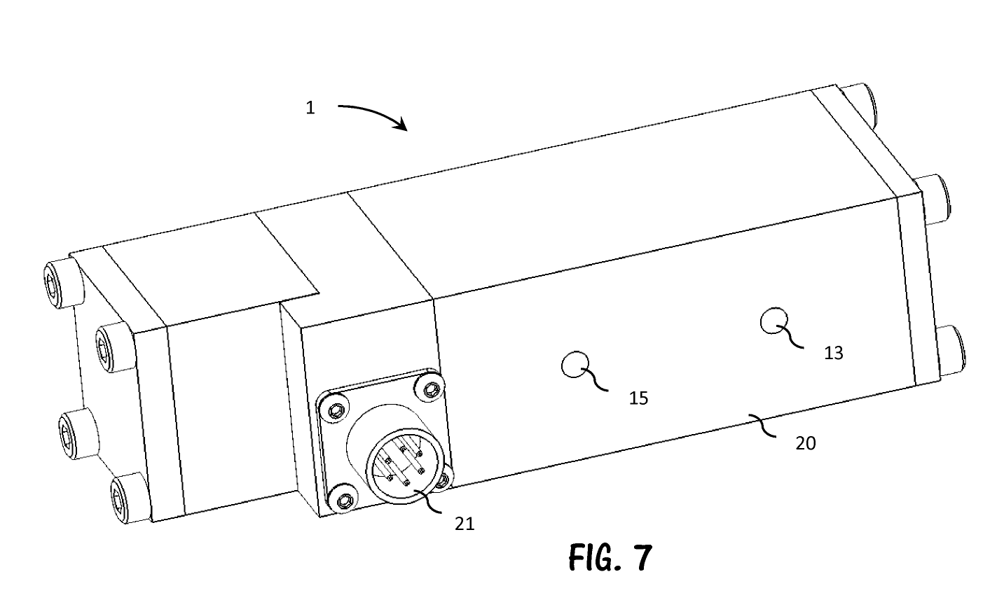

FIG. 7 further illustrates a perspective view of the valve depicted in FIGS. 1-4.

In another embodiment of the invention, a method for independently controlling gas-flow and expansion thereof comprises: (i) providing a cryocooler connected to a linear valve assembly as described above; and (ii) translating a linear armature within said valve to open, close, and restrict one or more gas-flow ports. In one embodiment, the method may further comprise the step of providing an input and exhaust function in reverse-phase for heating a cryogenic region of the cryocooler. In another embodiment, the method includes translating the armature to partially restrict gas-flow between two peripheral grooves.

In another embodiment of the invention, the valve comprises an armature, housing member and an elongated sleeve. The armature comprises a permanent magnet at its proximal end. The valve assembly housing comprises a coil of conducting wire positioned radially outward from the region surrounding the armature. A current flowing through the coiled conductor creates an electromagnetic field. The fixed magnetic field of the armature provides a means to translate the armature according to the state of current flow about the coiled conductor of the housing.

In another embodiment, the valve comprises an armature, housing member and an elongated sleeve. The armature is driven by a screw-drive or similar linear translation mechanism.

In another embodiment, the valve comprises an armature, a housing member, and an elongated sleeve. The armature comprises radial slots in its inner diameter. The slot pattern is designed to allow for the armature to change valve orientation by means of rotation. In this embodiment the exhaust and intake ports may be displaced horizontally as well as vertically. An electrical motor may be used to drive rotation.

The above examples are set forth for illustrative purposes and are not intended to limit the spirit and scope of the invention. One having skill in the art will recognize that deviations from the aforementioned examples can be created which substantially perform the same functions and obtain similar results.

I claim:

1. A valve assembly for dynamically controlling gas-flow about one or more cryogenic regions of a cryocooler, comprising:
an armature extending along a translational axis from a proximal end to a distal end, said armature comprising a linear rod portion having at least one circumferential notch disposed along a length thereof and at least partially comprising an electric motor at said proximal end;
an elongated sleeve coaxially disposed about said translational axis and having an outer diameter and an inner diameter, said elongated sleeve comprising two or more peripheral grooves axially disposed along a length of the elongated sleeve, said peripheral grooves each comprising a plurality of radial apertures disposed along a circumference thereof; and
a housing member adapted to contain said armature and elongated sleeve, said housing member comprising a first input port and a first exhaust port, said first input port extending outwardly from a first of said two or more peripheral grooves of said elongated sleeve, said first exhaust port extending outwardly from a second of said two or more peripheral grooves of said elongated sleeve;
wherein said valve assembly is operated independently from displacer mechanics of an attached cryocooler.

2. The valve assembly of claim 1, wherein at least a portion of said linear rod portion is coated with a polymer.

3. The valve assembly of claim 2, wherein said polymer comprises PTFE.

4. The valve assembly of claim 1, wherein said elongated sleeve is fabricated from one of stainless steel or brass.

5. The valve assembly of claim 1, said valve capable of reversing one or more of an input phase and exhaust phase for warming said attached cryocooler.

6. The valve assembly of claim 1, said housing member further comprising a base.

7. The valve assembly of claim 6, said base further comprising at least one of: iron, nickel, or cobalt.

8. The valve assembly of claim 7, said housing member further comprising one or more permanent magnets fixedly disposed near said base.

9. The valve assembly of claim 8, said base and said permanent magnets forming a stator.

10. The valve assembly of claim 1, wherein said two or more peripheral grooves of said elongated sleeve are adapted to maintain a positive pressure therein.

11. The valve assembly of claim 1, further comprising an encoder for reading a code strip, wherein said code strip is attached to said armature.

12. The valve assembly of claim 11, wherein said encoder is adapted for communication with a microprocessor such that an instantaneous position of said armature can be dynamically controlled by said microprocessor.

13. The valve assembly of claim 1, said at least one circumferential notch of said armature comprising a first circumferential notch and a second circumferential notch.

14. The valve assembly of claim 13, said two or more peripheral grooves of said elongated sleeve comprising a first peripheral groove, a second peripheral groove, a third peripheral groove, and a fourth peripheral groove.

15. The valve assembly of claim 14, wherein said armature is adapted to translate from a first translational point to a second translational point along said translational axis.

16. The valve assembly of claim 15, wherein said armature is further adapted to translate to a third translational point along said translational axis.

17. The valve assembly of claim 15, wherein said first circumferential notch of said armature being disposed at said first translational point is adapted to promote gas-flow between said first and second peripheral grooves of said elongated sleeve.

18. The valve assembly of claim 15, wherein said first circumferential notch of said armature being disposed at said second translational point is adapted to prevent gas-flow between said first and second peripheral grooves of said elongated sleeve.

19. The valve assembly of claim 16, wherein said first circumferential notch of said armature being disposed at said third translational point is adapted to restrict gas-flow between said first and second peripheral grooves of said elongated sleeve.

20. A method for independently controlling a flow of gas about one or more cryogenic regions of a cryocooler, comprising:
a. providing the valve of claim 1; and
b. translating said armature of said valve back and forth within said elongated sleeve for controlling a flow of gas about a cryogenic region.

21. The method of claim 20, wherein said armature is translated in reverse-phase for providing a heating mechanism.

22. The method of claim 20, wherein said armature is translated to a point wherein said circumferential notch of said armature is adapted to partially restrict a flow of gas between two or more of said input and exhaust ports.
